(19) United States
(12) Patent Application Publication
(10) Pub. No.: US 2006/0112516 A1
(43) Pub. Date: Jun. 1, 2006

(54) Hinge assembly for portable electronic devices

(75) Inventors: Rui-Hao Chen, Shenzhen (CN); Peng-Jin Ge, Shenzhen (CN); Ye Liu, Shenzhen (CN); Tai-Jun Liu, Shenzhen (CN); Hsiao-Hua Tu, Tu-cheng (TW); Chia-Hua Chen, Tu-cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD, Shindian City (TW)

(21) Appl. No.: 11/228,942

(22) Filed: Sep. 16, 2005

(30) Foreign Application Priority Data
Nov. 27, 2004 (CN) 200410052506.3

(51) Int. Cl. E05D 11/10

(52) U.S. Cl. 16/330

(57) ABSTRACT

A hinge assembly (100), for joining a flip cover section (110) to a body section (120) of a foldable electronic device (102), includes a shaft (1), at least one pin (2), a spring (3) and a sleeve (4). The shaft includes a body portion (11) and a resisting portion (14). The resisting portion is disposed at one end of the body portion, and the body portion has at least one pin hole therein. Each pin is engaged with a respective pin hole of the shaft. The spring is placed around the resisting portion of the shaft. The sleeve includes a first portion (42) and a second portion (43). The second portion defines at least one sliding slot (44). Each pin protrudes out from a corresponding sliding slot. The hinge assembly is configured to permit a maximum angle (˜160 degrees) between the cover section and the body section.

### BACKGROUND OF THE INVENTION

1. Field of the Invention

The present invention relates to hinge assemblies and, particularly, to a hinge assembly for foldable electronic devices such as portable telephones, portable computers, and so on.

2. Discussion of the Related Art

At present, perhaps the most popular portable electronic device in the marketplace is the foldable cellular telephone, which generally includes a cover section and a body section. The cover section and the body section are rotatably interconnected through a hinge assembly, for switching the telephone between an in-use position and a closed position.

One kind of hinge assembly uses a torsion coil spring to make the cover section open up from the body section and be held in an open position. An example of such kind of hinge assembly is disclosed in U.S. Pat. No. 6,493,542 and is represented in FIG. 4 (Prior Art) herein. That hinge assembly 90 includes a sleeve 91, a torsion spring 92, and a main shaft 93.

The sleeve 91 is substantially a hollow cylinder, with an open end and an opposite closed end. Disposed proximate the opposite closed end is an end portion 912 for latching with a cover section of a foldable cellular telephone. Also near the opposite closed end but opposing end portion 912 is defined a blind receiving hole 914, with inner threads. The sleeve 91 further includes two opposite slots 916, 918 formed in sidewalls thereof. A height of the slot 916 is greater than that of the opposite slot 918. A given finger 922, 924 extends from one end of the torsion spring, respectively. The main shaft 93 has a fixing portion 932 at one end thereof and a flange 934 at another opposite end. The fixing portion 932 has outer threads defined thereon.

In assembly, the torsion spring 92 is received in the sleeve 91. The fingers 922, 924 protrude from the slots 916, 918 of the sleeve 91, respectively. The finger 924 is engaged with the body section (not shown) of the foldable cellular telephone (not shown). The main shaft 93 is inserted into the sleeve 91, and the fixing portion 932 is mounted into the blind receiving hole 914 of the sleeve 91. The hinge assembly 90 thus is completely assembled. The duly assembled hinge assembly 90 is then received in the body section of the foldable cellular telephone. The end portion 912 is engaged with the cover section (not shown), and the finger 924 is engaged with the body section. When the cover section is closed, the torsion spring 92 has a predetermined torsion. At the same time, the cover section is mated through a locking mechanism (not shown) such as magnet. The magnetic force can make the cover section close to the body section.

When in use, the locking mechanism is released, and the cover section is opened via the torsion of the spring 92. The structure of the hinge assembly is simple, and the operation is convenient. However, the torsion force of the whole hinge assembly suffers from the end portion 912 of the sleeve 91. The end portion 912 is small, so the end portion 912 requires a higher strength. Furthermore, the impact force burdens the body section and the cover section. The body section and the cover section, as such, are easily worn, thereby shortening the working lifetime of the foldable cellular telephone.

Therefore, there is a need for a new hinge assembly that overcomes the above-described problems.

### SUMMARY OF THE INVENTION

Accordingly, what is needed is a hinge assembly for devices such as mobile phones, in which the hinge assembly itself opens the device to a desired angle.

To achieve the above-mentioned object, a hinge assembly of the present invention generally includes a shaft, at least one pin, a spring and a sleeve. The shaft has a body portion and a resisting portion. The resisting portion is disposed at one end of the body portion, and the body portion defines at least one pin hole. Each pin is engaged with a respective pin hole of the shaft. The spring is placed around the resisting portion of the shaft. The sleeve includes a first portion and a second portion, the second portion defining at least one sliding slot, each pin being configured for engaging and protruding out from a given sliding slot. The hinge assembly controls an angle of the cover section relative to the body section by means of its configuration. Therefore, the body section or the cover section does need to be specially designed. Furthermore, each time the cover section is opened, the impact force transferred thereto is small and, as such, the cover section is not liable to become worn or damaged from the effects of opening and closing the phone.

Other objects, advantages and novel features of the invention will become more apparent from the following detailed description when taken in conjunction with the accompanying drawings.

### BRIEF DESCRIPTION OF THE DRAWINGS

FIG. 1 is an isometric view of an embodiment of the hinge assembly of the present invention, as used in a mobile phone;

FIG. 2 is an exploded, isometric view of the embodiment of the hinge assembly shown in FIG. 1;

FIG. 3 is an assembled view of the hinge assembly shown in FIGS. 1 and 2; and

FIG. 4 is an exploded, isometric view of a conventional hinge assembly.

### DETAILED DESCRIPTION OF THE EMBODIMENTS

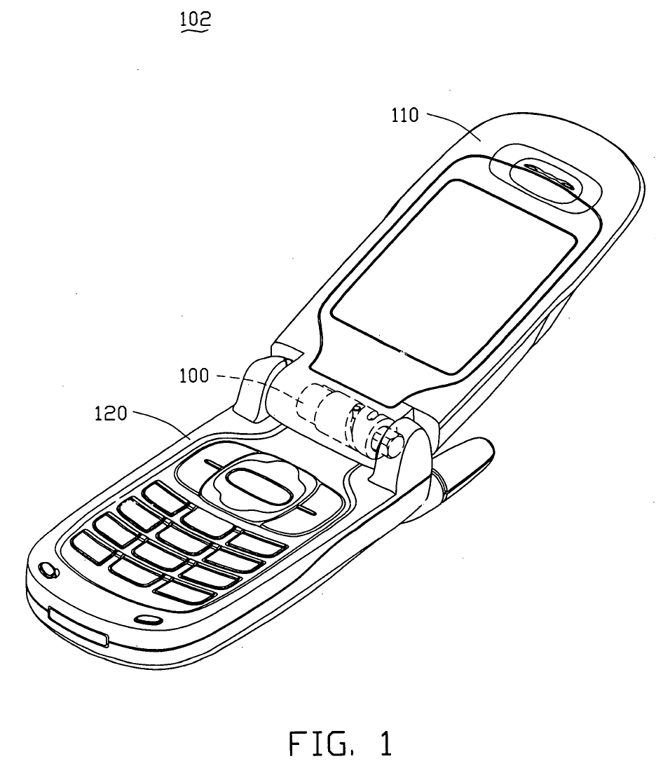

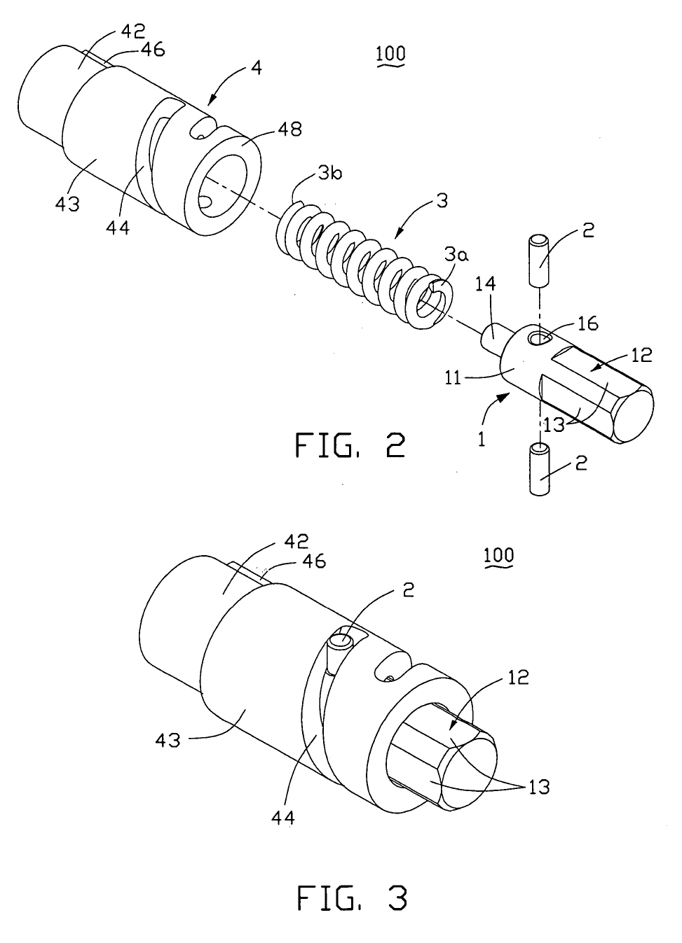

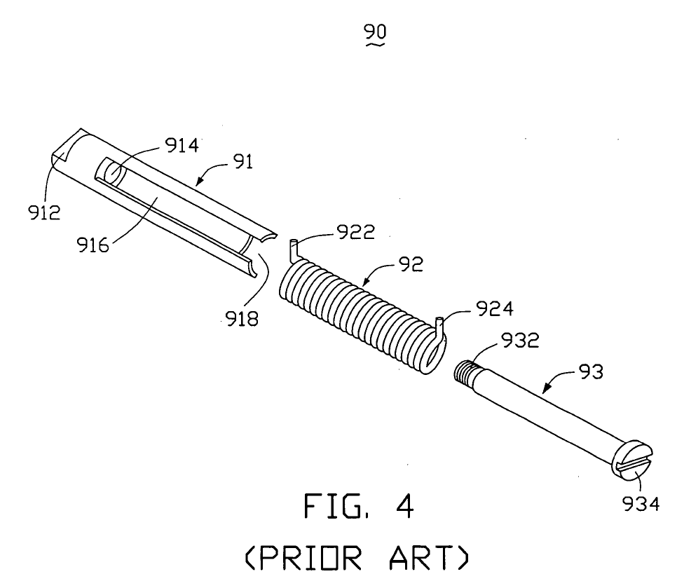

Referring now to the drawings in detail, FIG. 1 and FIG. 2 show a hinge assembly 100, applied to a portable electronic device 102 such as a flip-type mobile phone, for pivotably coupling a cover section 110 and a body section 120 together.

The hinge assembly 100, in the embodiment illustrated, includes a shaft 1, two pins 2, a spring 3, and a sleeve 4.

The shaft 1 includes a body portion 11, a fixing portion 12, and a resisting portion 14. The body portion 11 is substantially a cylinder. The fixing portion 12 is disposed on end of the body portion 11, the fixing portion 12 defining several fixing planes 13 in a sidewall thereof, the fixing planes 13 being configured for engaging with the cover section 110 of the mobile phone 102. The resisting portion 14 is disposed on the body portion 11 at the end thereof opposite the fixing portion 12. An outer diameter of the resisting portion 14 is smaller than a diameter of the body portion 11, the resisting portion thereby being configured for receiving the spring 3 therearound. The shaft 1 has two pin holes 16 defined therein, positioned opposite on another. An axis of each pin hole 16 is perpendicular to an axis of the shaft 1.

Each pin 2 is substantially a cylinder. One end of the pin 2 is received, preferably tightly, in a given pin hole 16 of the shaft 1. Each mounted pin 2 advantageously is perpendicular or at least essentially perpendicular to the shaft 1.

The spring 3 is substantially a cylinder (i.e., occupying a cylindrical volume), the spring 3 having a first end section 3a and a second end section 3b. One end section 3a of the spring 3 coils about and engages the resisting portion 14 of the shaft 1. The second end section 3b of spring 3 is to be inserted and resiliently engaged within sleeve 4.

The sleeve 4 includes a first portion 42 and a second portion 43. The first portion 42 is solid and substantially cylinder, and the second portion 43 is substantially a hollow cylinder. An outer diameter of the first portion 42 is smaller than an outer diameter of the second portion 43. The first portion 42 includes a protrusion block 46 configured for engaging with the body section 120 of a mobile telephone 102. The second portion 43 of the sleeve 4 has an open end portion 48. The second portion 43 defines two sliding slots 44, with communication to the open end portion 48 of the sleeve 4. A middle axis of each sliding slot 44 is tilted with respect to the axis of the sleeve 4. When turned about the sleeve axis from one end of the sliding slot 44 to one opposite end of the sliding slot 44, the sleeve 4 can be rotated about 160 degrees (i.e., the maximum angular travel distance allowed by hinge 100).

In assembly, referring to FIGS. 2 and 3, the spring 3 is received in the second portion 43 of the sleeve 4 and, upon being fully inserted, engages against the first portion 42 of the sleeve 4, then the shaft 1 (particularly resisting portion 14) is inserted into the sleeve 4. The spring 3 is pushed via resisting portion 14 into the sleeve 4 through second portion 43 and into engagement with the first portion 42 so that the spring 3 effectively has a predetermined pressure associated therewith. An angle of the shaft 1 to the sleeve 4 is adjusted, for aligning the pin hole 16 to the sliding slot 44 of the sleeve 4. Each pin 2 passes through a respective sliding slot 44 and is inserted into a respective pin hole 16 within the shaft 1. Each pin 2 is tightly engaged with a respective pin hole 16, for mounting in the shaft 1. Therefore, the hinge assembly 100 is completed.

The duly assembled hinge assembly 100 is then received within mobile phone 102 for connecting the cover section 110 and the body section 120. The fixing portion 12 is engaged with the cover section 110, via the fixing or locking planes 13. The sleeve 4 is received with the body section 120, the protrusion block 46 being engaged with the body section 120.

When the mobile telephone 102 is in a closed state, the cover section 110 is closed to the body section 120 by means of a locking mechanism (i.e., combined action of the spring 3 and the interaction of pins 2 with corresponding sliding slots 44). When in use, the locking mechanism is released. Each pin 2 slides along each sliding slot 44 of the sleeve 4 because of the pulling of the spring 3, causing the shaft 1 to rotate. Accordingly, the cover section 110 rotates relative to the body section 120. When the pin 2 slides to the opposite end of the sliding slot 44, the shaft 1 stops rotating. Therefore, the cover section 110 is open.

As described above, the present invention provides a hinge assembly 100 for use with any various portable devices 102, beyond the mobile phone illustrated. When the locking mechanism is released, the hinge assembly 100 fully opens the cover section 110 from body section 120. This provides the user with convenient one-handed operation of the device 102.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

We claim:

1. A hinge assembly for joining a flip cover section to a body section of a foldable electronic device, comprising:
a shaft comprising a body portion and a resisting portion, the resisting portion disposed at one end of the body portion, the body portion having at least one pin hole defined therein;
at least one pin, each pin engaging with a respective pin hole of the shaft;
a spring having a first spring end section, the first spring end section being placed around the resisting portion of the shaft; and
a sleeve comprising a first portion and a second portion, the second portion defining at least one sliding slot, each pin protruding out from a corresponding sliding slot.

2. The hinge assembly as claimed in claim 1, wherein each pin is tightly engaged with a respective pin hole.

3. The hinge assembly as claimed in claim 1, wherein an axis of the pin hole is essentially perpendicular to an axis of the shaft.

4. The hinge assembly as claimed in claim 1, wherein the shaft comprises a fixing portion, the fixing portion being located at an opposite end of the resisting portion, the fixing portion being configured for engaging with the cover section.

5. The hinge assembly as claimed in claim 1, wherein the first portion comprises a protrusion block, the protrusion block being configured for engaging with the body section.

6. The hinge assembly as claimed in claim 1, wherein the sliding slot is configured to allow rotation of the sleeve up to an angle of about 160 degrees relative to an axis of the sleeve.

7. The hinge assembly as claimed in claim 1, wherein the sliding slot is in communication with the second portion of the sleeve.

8. The hinge assembly as claimed in claim 1, wherein a middle axis of the sliding slot is tilted with respect to an axis of the sleeve.

9. The hinge assembly as claimed in claim 1, wherein the spring is inserted through the second portion of the sleeve and then engages and thereby resists the first portion of the sleeve.

10. The hinge assembly as claimed in claim 1, wherein the spring is essentially cylindrical.

11. A foldable electronic device having at least two components hinged together by a hinge assembly, said hinge assembly comprising:
a shaft comprising a body portion and a resisting portion, the resisting portion being disposed at one end of the body portion, the body portion defining at least one pin hole;
at least one pin, each pin engaging with a respective pin hole of the shaft;
a spring having a first spring end section, the first spring end section being placed around the resisting portion of the shaft; and a sleeve comprising a first portion and a second portion, the second portion defining at least one sliding slot, each pin protruding out from a corresponding sliding slot.

12. The hinge assembly as claimed in claim 11, wherein a middle axis of the sliding slot is tilted with respect to an axis of the sleeve.
